(19) United States
(12) Patent Application Publication
(10) Pub. No.: US 2014/0363020 A1
(43) Pub. Date: Dec. 11, 2014

(54) SOUND CORRECTING APPARATUS AND SOUND CORRECTING METHOD

(71) Applicant: FUJITSU LIMITED, Kawasaki-shi (JP)

(72) Inventor: Kaori Endo, Yokohama (JP)

(73) Assignee: FUJITSU LIMITED, Kawasaki-shi (JP)

(21) Appl. No.: 14/291,850

(22) Filed: May 30, 2014

(30) Foreign Application Priority Data
Jun. 7, 2013 (JP) 2013-121166

(51) Int. Cl. H04R 3/04; H04R 1/08

(52) U.S. Cl. CPC H04R 3/04; H04R 1/08
USPC 381/98

(57) ABSTRACT

A sound correcting apparatus includes an air-conduction microphone, a bone-conduction microphone, a processor, and a memory. The air-conduction microphone picks up an air conduction sound using aerial vibrations. The bone-conduction microphone picks up a bone conduction sound using bone vibrations of a user. The processor calculates a ratio of a voice of the user for the air conduction sound to a noise. The memory stores a correction coefficient for making a frequency spectrum of the bone conduction sound identical with a frequency spectrum of the air conduction sound which corresponds to the ratio that is equal to or greater than a first threshold. The processor corrects the bone conduction sound using the correction coefficient, and generates an output signal from the corrected bone conduction sound when the ratio is less than a second threshold.

### CROSS-REFERENCE TO RELATED APPLICATION

This application is based upon and claims the benefit of priority of the prior Japanese Patent Application No. 2013-121166, filed on Jun. 7, 2013, the entire contents of which are incorporated herein by reference.

### FIELD

The embodiments discussed herein are related to a method for correcting sounds input to an apparatus.

### BACKGROUND

When a user A in a noisy place speaks with a user B over, for example, the telephone, ambient sounds are mixed in with the voice of the user A input through an air-conduction microphone. In this case, it is difficult for the user B to hear the voice of the user A that reaches a terminal used by the user B. Attempts have been made to reduce noise in a signal input through an air-conduction microphone, but, under a condition of a degraded signal-to-noise ratio (SNR), the strength of a user's voice components may be decreased in addition to reducing the noise, thereby decreasing the sound quality. A user's voice may be input using a bone-conduction microphone, which muffles sounds due to a low sensitivity to high-frequency-band sounds. In addition, voice is not input through a bone-conduction microphone when it is not in contact with a user, and this means that voice may not be able to be input through a bone-conduction microphone mounted on a terminal, depending on how the user holds the terminal.

Accordingly, the combined use of an air-conduction microphone and a bone-conduction microphone has been studied. As an example, a communication apparatus is known that determines an ambient noise level according to a received talk signal, a sound signal picked up by an air-conduction microphone, and a sound signal picked up by a bone-conduction microphone, and that selects the air-conduction microphone or the bone-conduction microphone according to the ambient noise level. A microphone apparatus is also known that merges air-conduction output components obtained from an air-conduction microphone with bone-conduction output components obtained from a bone-conduction microphone. The microphone apparatus increases the proportion of the air-conduction output components relative to the bone-conduction output components when an outside noise level is low, and decreases the proportion of the air-conduction output components relative to the bone-conduction output components when the outside noise level is high. Moreover, a handset apparatus has been devised that puts a transmission amplification circuit in an in-operation mode when the output level of a bone-conduction microphone exceeds the output level of an air-conduction microphone.

Japanese Laid-open Patent Publication Nos. 8-70344, 8-214391, and 2000-354284 are known.

In the combined use of an air-conduction microphone and a bone-conduction microphone, a sound signal output from the bone-conduction microphone is used as a user's voice when an SNR is low due to, for example, a loud noise. However, since the bone-conduction microphone has a low sensitivity to high-frequency-band sounds, use of the bone-conduction microphone produces muffled sounds that are difficult to hear. Thus, a low SNR leads to a difficulty in hearing a user's voice even when a bone-conduction microphone is used.

### SUMMARY

According to an aspect of the embodiments, a sound correcting apparatus includes an air-conduction microphone, a bone-conduction microphone, a processor, and a memory. The air-conduction microphone picks up an air conduction sound using aerial vibrations. The bone-conduction microphone picks up a bone conduction sound using bone vibrations of a user. The processor processes the air conduction sound and the bone conduction sound. The memory stores data used by the processor. The processor calculates a ratio of a voice of the user for the air conduction sound to a noise. The memory stores a correction coefficient for making a frequency spectrum of the bone conduction sound identical with a frequency spectrum of the air conduction sound which corresponds to the ratio that is equal to or greater than a first threshold. The processor corrects the bone conduction sound using the correction coefficient, and generates an output signal from the corrected bone conduction sound when the ratio is less than a second threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a flowchart illustrating an exemplary method for selecting the type of a signal.

FIG. 2 illustrates an exemplary configuration of a sound correcting apparatus.

FIG. 3 illustrates an exemplary hardware configuration of a sound correcting apparatus.

FIG. 4 is a flowchart illustrating an exemplary process performed in a first embodiment.

FIG. 5 illustrates an exemplary method for generating a frame and an example of generation of a frequency spectrum.

FIG. 6 illustrates a table indicating an example of correction coefficient data.

FIG. 7 illustrates examples of temporal changes in the intensities of an air conduction sound and a bone conduction sound.

FIG. 8 is a flowchart illustrating exemplary processes performed by a contact detecting unit.

FIG. 9 is a table illustrating an exemplary method for selecting a sound to be output.

FIG. 10 illustrates an exemplary method for deciding the type of an input sound.

FIG. 11 is a flowchart illustrating exemplary operations performed by a class determining unit.

FIG. 12 is a flowchart illustrating exemplary operations performed by an SNR calculating unit.

FIG. 13 illustrates an exemplary correcting method used by a bone-conduction-sound correcting unit.

FIG. 14 illustrates an example of a bone conduction sound corrected using an adjusted correction coefficient.

FIG. 15 is a graph illustrating an exemplary method for adjusting a correction coefficient, wherein the method is used by a bone-conduction-sound correcting unit.

FIG. 16 is a flowchart illustrating exemplary processes performed by a bone-conduction-sound correcting unit to adjust a correction coefficient.

FIG. 17 is a table illustrating an exemplary method for selecting a sound to be output.

FIG. 18 is a flowchart illustrating exemplary processes performed in a third embodiment.

### DESCRIPTION OF EMBODIMENTS

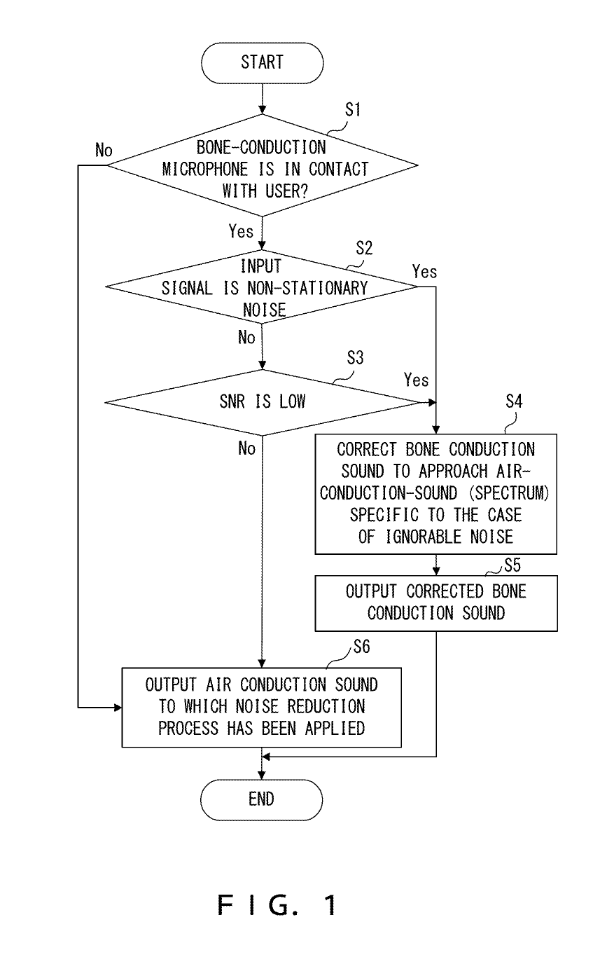

FIG. 1 is a flowchart illustrating an exemplary method for selecting the type of a signal. A sound correcting apparatus in accordance with an embodiment includes both an air-conduction microphone and a bone-conduction microphone. The sound correcting apparatus holds a correction coefficient for making the frequency spectrum of a signal input through the bone-conduction microphone identical with the frequency spectrum of a signal input through the air-conduction microphone, wherein a sound input in an environment in which the influence of noise is ignorable is used to obtain the correction coefficient. As an example, a value that is the intensity of a signal obtained by the air-conduction microphone divided by the intensity of a signal obtained by the bone-conduction microphone is used as the correction coefficient. The correction coefficient is determined for each frequency bandwidth having a range determined in advance. A signal input through the air-conduction microphone and a signal input through the bone-conduction microphone may hereinafter be referred to as an “air conduction sound” and a “bone conduction sound”, respectively.

Receiving an input from the air-conduction microphone embedded in the sound correcting apparatus, the sound correcting apparatus judges whether the bone-conduction microphone is in contact with a user by using the magnitude of a signal input through the bone-conduction microphone (step S1). When the bone-conduction microphone is in contact with the user, the sound correcting apparatus partitions the input sound signal into frames each associated with a predetermined length. For each frame, the sound correcting apparatus judges whether the input signal is a non-stationary noise (step S2). The “non-stationary noise” is a noise that is not constantly generated during a period in which sounds are input to the sound correcting apparatus, and the level of such a noise significantly changes while sounds are input to the sound correcting apparatus. Non-stationary noises include, for example, noises of an announcement, noises generated when, for example, a train departs or arrives, and the sound of a car horn. Noise constantly generated while sounds are input to the sound correction apparatus may hereinafter be referred to as “stationary noise”. Descriptions will hereinafter be given in detail of a method for determining whether a picked-up sound is a non-stationary noise. Determining that a frame includes a non-stationary noise, the sound correcting apparatus corrects a signal input through the bone-conduction microphone using the stored correction coefficient (Yes in step S2). As a result of the correction, a bone-conduction-sound spectrum is corrected to approach an air-conduction-sound spectrum specific to the case of an ignorable noise (step S4). The sound correcting apparatus outputs the corrected bone conduction sound (step S5).

Determining that a frame does not include a non-stationary noise, the sound correcting apparatus judges whether the value of SNR for the processing-object frame is lower than a threshold (No in step S2; step S3). When the value of SNR for the processing-object frame is lower than the threshold, the sound correcting apparatus outputs, as an obtained sound, the bone conduction sound corrected to approach an air-conduction-sound (spectrum) specific to the case of an ignorable noise in the processes of steps S4 and S5.

Meanwhile, when the value of SNR is equal to or higher than the threshold, the sound correcting apparatus outputs, as an obtained sound, an air conduction sound to which a noise reduction process has been applied (No in step S3; step S6). When the bone-conduction microphone is not in contact with the user, the sound correcting apparatus also outputs, as an obtained noise, an air conduction sound to which the noise decreasing process has been applied (No in step S1; step S6).

As described above, when a noise is expected to largely affect a sound input through the air-conduction microphone, e.g., when a non-stationary noise is present or when the value of SNR is lower than the threshold, the sound correcting apparatus in accordance with the embodiment generates, from a corrected bone conduction sound, a sound to be output. Note that the bone conduction sound is corrected to approach an air conduction sound specific to the case of an ignorable noise. Hence, the sound correcting apparatus may adjust the sensitivity in high frequencies of bone conduction sounds in accordance with air conduction sounds while removing noise using the bone conduction sounds. Therefore, even in the case of using a bone conduction sound, the sound correcting apparatus may output an easily heard sound by correcting the intensity of a sound of high frequency.

<Apparatus Configuration>

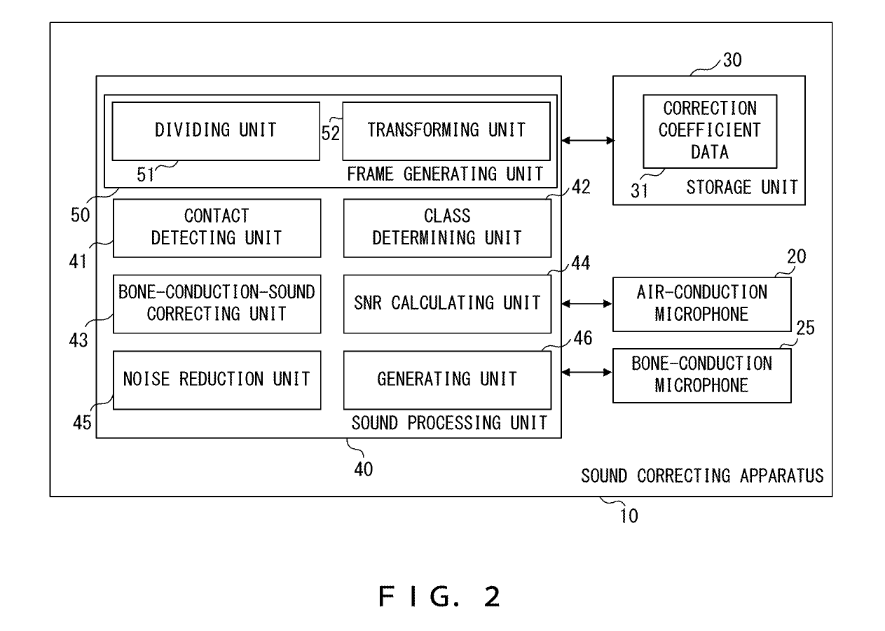

FIG. 2 illustrates an exemplary configuration of a sound correcting apparatus 10. The sound correcting apparatus 10 includes an air-conduction microphone 20, a bone-conduction microphone 25, a storage unit 30, and a sound processing unit 40. The sound processing unit 40 includes a frame generating unit 50, a contact detecting unit 41, a class determining unit 42, a bone-conduction-sound correcting unit 43, an SNR calculating unit 44, a noise reduction unit 45, and a generating unit 46. The frame generating unit 50 includes a dividing unit 51 and a transforming unit 52.

The air-conduction microphone 20 picks up a sound using aerial vibrations generated around the air-conduction microphone 20. Thus, the air-conduction microphone 20 not only picks up the voice of a user of the sound correcting apparatus 10 but also a stationary noise or a non-stationary noise generated around the sound correcting apparatus 10. Since the bone-conduction microphone 25 picks up a sound using bone vibrations of the user of the sound correcting apparatus 10, the bone-conduction microphone 25 picks up the user's voice but does not pick up a stationary noise or a non-stationary noise.

The dividing unit 51 divides sound data respectively picked up by the air-conduction microphone 20 and the bone-conduction microphone 25 into pieces each associated with a frame. The word “frame” used herein indicates a predetermined time period for generating sound data to be output from the sound correcting apparatus 10. For each frame, the sound correcting apparatus 10 determines which of an air conduction sound or a bone conduction sound is to be used to generate a sound intended to be used as an output of the sound correcting apparatus 10. Each frame has a sequence number assigned thereto. In addition, each frame number is associated with a signal of an air conduction sound and a signal of a bone conduction sound usable to generate an output signal for a period indicated by the frame. For each frame, the transforming unit 52 performs Fourier transformation on data on an obtained air conduction sound and data on an obtained bone conduction sound so as to generate frequency spectrums. Each frequency spectrum is associated with information indicating which of an air conduction sound or a bone conduction sound the data used to calculate the spectrum is, and with the frame number of a frame that includes the data used to calculate the frequency spectrum. The transforming unit 52 outputs frequency spectrums obtained for each frame to the contact detecting unit 41.

The contact detecting unit 41 judges for each frame whether the bone-conduction microphone 25 is in contact with a user. The bone-conduction microphone 25 picks up a bone conduction sound for a frame for which the contact detecting unit 41 detects that the bone-conduction microphone 25 is in contact with the user. The contact detecting unit 41 judges for each frame whether the user is in contact with the bone-conduction microphone 25 by comparing the intensities of input signals between a bone conduction sound and an air conduction sound. Assume that the contact detecting unit 41 totalizes the powers in frequency bands from the frequency spectrum of an air conduction sound for a processing-object frame so as to obtain the intensity of the air conduction sound for the processing-object frame. The contact detecting unit 41 also calculates the sound intensity of a bone conduction sound in a similar manner. Judging that the bone-conduction microphone 25 is not in contact with the user, the contact detecting unit 41 makes, for the processing-object frame, a request for the noise reduction unit 45 to reduce a noise within an air conduction sound and, in addition, makes a request for the generating unit 46 to select an output from the noise reduction unit 45 as a sound output from the sound correcting apparatus 10. Meanwhile, for a frame for which it is judged that the bone-conduction microphone 25 is in contact with the user, the contact detecting unit 41 outputs processing-object frequency spectrums of both an air conduction sound and a bone conduction sound to the class determining unit 42.

For each frame, the class determining unit 42 judges which of the user's voice, a stationary noise, or a non-stationary noise a picked-up air conduction sound includes as a main element. In making the judgment, the class determining unit 42 uses a difference in intensity of input signals between an air conduction sound and a bone conduction sound for a processing-object frame. Assume that the class determining unit 42 also calculates a sound intensity from a frequency spectrum for each frame, as with the contact detecting unit 41. An exemplary determination made by the class determining unit 42 will be described hereinafter. For a frame judged to be associated with an air conduction sound that includes a non-stationary noise, the class determining unit 42 makes a request for the bone-conduction-sound correcting unit 43 to correct a bone conduction sound and also makes a request for the generating unit 46 to select an output from the bone-conduction-sound correcting unit 43 as a sound output from the sound correcting apparatus 10. Meanwhile, for a frame judged to mainly include the user's voice as an air conduction sound, the class determining unit 42 makes a request for the SNR calculating unit 44 to calculate a value of SNR for the air conduction sound. So that the SNR calculating unit 44 can calculate the average intensity of stationary noise, the class determining unit 42 outputs, to the SNR calculating unit 44, the frequency spectrum of an air conduction noise obtained from a frame that includes the stationary noise.

The bone-conduction-sound correcting unit 43 corrects a bone conduction sound at a request from the class determining unit 42 or the SNR calculating unit 44. In this case, the bone-conduction-sound correcting unit 43 obtains the frequency spectrum of the bone conduction sound from the class determining unit 42. In addition, the bone-conduction-sound correcting unit 43 uses correction coefficient data 31. An exemplary method for correcting a bone conduction sound will be described hereinafter. The bone-conduction-sound correcting unit 43 outputs the frequency spectrum of a corrected bone conduction sound to the generating unit 46.

At a request from the class determining unit 42, the SNR calculating unit 44 calculates the value of SNR for an air conduction sound for each frame. In this case, as with the contact detecting unit 41 and the class determining unit 42, the SNR calculating unit 44 calculates a sound intensity from a frequency spectrum for each frame and determines the average value of the sound intensities for the frames within a stationary noise section. The SNR calculating unit 44 divides the sound intensity of an air conduction sound obtained from the frames within a sound section for which a value of SNR is determined by the average value of the sound intensities for the frames within the stationary noise section, thereby determining a value of SNR for each frame of an air conduction sound judged to be in the sound section. The SNR calculating unit 44 compares the value of SNR obtained for each frame with a threshold. When the value of SNR is equal to or higher than the threshold, the SNR calculating unit 44 makes, for a processing-object frame, a request for the noise reduction unit 45 to reduce a noise within an air conduction sound, and also makes a request for the generating unit 46 to select an output from the noise reduction unit 45 as a sound output from the sound correcting apparatus 10. Meanwhile, when the value of SNR is lower than the threshold, the SNR calculating unit 44 makes, for a processing-object frame, a request for the bone-conduction-sound correcting unit 43 to correct a bone conduction sound, and also makes a request for the generating unit 46 to select an output from the bone-conduction-sound correcting unit 43 as a sound output from the sound correcting apparatus 10.

For each frame, the noise reduction unit 45 performs a process for reduction of a stationary noise within an air conduction sound. As an example, the noise reduction unit 45 may reduce a stationary noise using a known arbitrary process such as a spectral subtraction method or a Wiener filtering method. The noise reduction unit 45 outputs, to the generating unit 46, the frequency spectrum of an air conduction sound with a noise being reduced.

For each frame, the generating unit 46 obtains, from data input from the noise reduction unit 45 and the bone-conduction-sound correcting unit 43, a frequency spectrum for a sound used as data obtained from the frame. The generating unit 46 generates time-domain data by performing inverse Fourier transformation on the obtained spectrum. The generating unit 46 deals with the obtained time-domain data as a sound output from the sound correcting apparatus 10. When, for example, the sound correcting apparatus 10 is a communication apparatus such as a mobile phone terminal, the generating unit 46 can output obtained time-domain sound data to, for example, a processor that performs speech encoding as an object to be transmitted from the communication apparatus.

The storage unit 30 holds correction coefficient data 31 used to correct a bone conduction sound and data used to correct a bone conduction sound. In addition, the storage unit 30 may store data used in a process performed by the sound processing unit 40 and data obtained through a process performed by the sound processing unit 40.

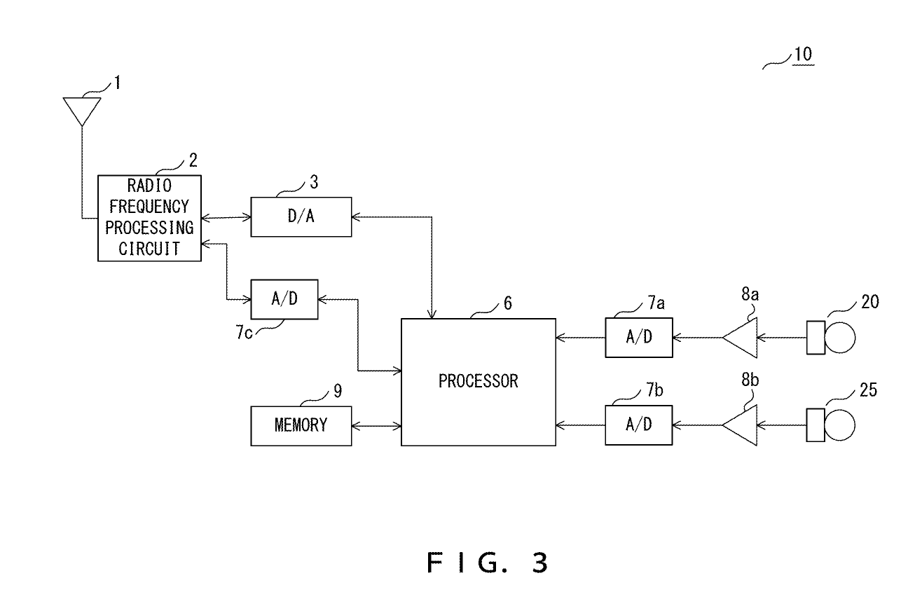

FIG. 3 illustrates an exemplary hardware configuration of the sound correcting apparatus 10. The sound correcting apparatus 10 includes a processor 6, a memory 9, an air-conduction microphone 20, and a bone-conduction microphone 25. The sound correcting apparatus 10 may include, as optional elements, an antenna 1, a radio frequency processing circuit 2, a digital-to-analog (D/A) converter 3, analog-to-digital (A/D) converters 7 (7a-7c), and amplifiers 8 (8a and 8b). The sound correcting apparatus 10 that includes, for example, the antenna 1 and the radio frequency processing circuit 2 as depicted in FIG. 3 functions as a communication apparatus capable of performing a radio frequency communication, such as a handheld unit.

The processor 6 is operated as the sound processing unit 40. Under a condition in which the sound correcting apparatus 10 is an apparatus that performs a radio communication, the processor 6 also processes a baseband signal and performs processing such as speech encoding. The radio frequency processing circuit 2 modulates or demodulates an RF signal received via the antenna 1. The D/A converter 3 transforms an input analog signal into a digital signal. The memory 9, which is operated as the storage unit 30, holds data used in processing performed by the processor 6 and data obtained through processing performed by the processor 6. In addition, the memory 9 may store a program operated in the sound correcting apparatus 10 in a non-transitory manner. The processor 6 functions as the sound processing unit 40 by reading and operating a program stored in the memory 9.

The amplifier 8a amplifies and outputs, to the A/D converter 7a, an analog signal input through the air-conduction microphone 20. The A/D converter 7a outputs the signal input from the amplifier 8a to the sound processing unit 40. The amplifier 8b amplifies and outputs, to the A/D converter 7b, an analog signal input through the bone-conduction microphone 25. The A/D converter 7b outputs the signal input from the amplifier 8b to the sound processing unit 40.

### First Embodiment

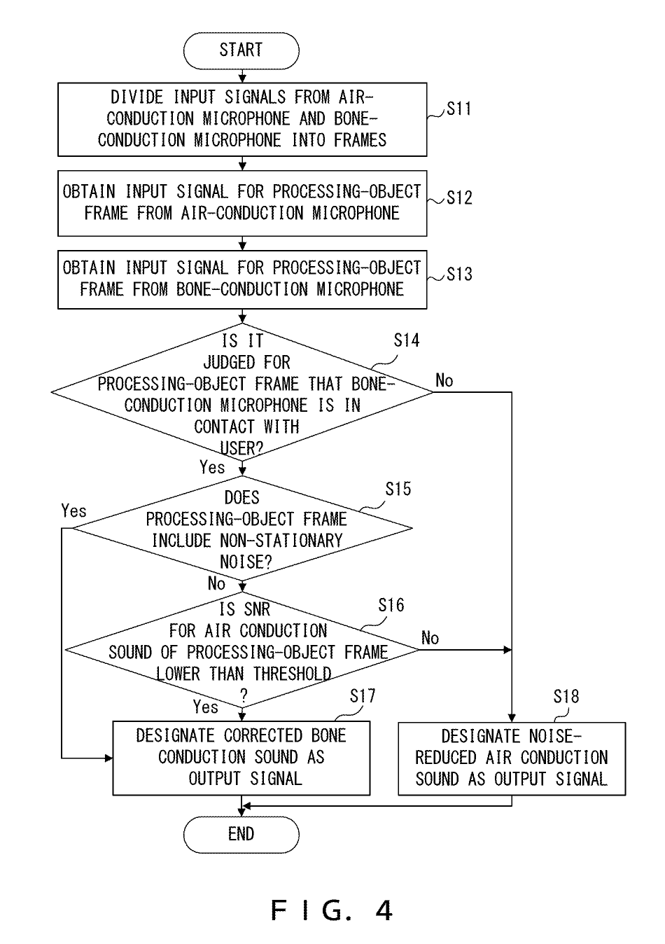

FIG. 4 is a flowchart illustrating an exemplary process performed in a first embodiment. First, the dividing unit 51 obtains input signals from the air-conduction microphone 20 and the bone-conduction microphone 25 and divides these signals into frames (step S11). The contact detecting unit 41 obtains input signals for a processing-object frame from both the air-conduction microphone 20 and the bone-conduction microphone 25 (steps S12 and S13). The contact detecting unit 41 judges for the processing-object frame whether the bone-conduction microphone 25 is in contact with a user (step S14). When the bone-conduction microphone 25 is in contact with the user, the class determining unit 42 judges for the processing-object frame whether the air conduction sound includes a non-stationary noise (Yes in step S14; step S15). For a frame judged to not include a non-stationary noise, the SNR calculating unit 44 calculates a value of SNR and judges whether this value is lower than a threshold (No in step S15; step S16). When the value of SNR is lower than the threshold, the generating unit 46 designates a signal of a corrected bone conduction sound as a sound output for the processing-object frame (Yes in step S16; step S17). Meanwhile, when the value of SNR is equal to or higher than the threshold, the generating unit 46 designates, as a sound output for the processing-object frame, a signal of an air-conduction sound with a noise being reduced (No in step S16; step S18). In addition, when it is judged that the processing-object frame includes a non-stationary noise, the generating unit 46 designates a signal of a corrected bone-conduction sound as a sound output for the processing-object frame (Yes in step S15; step S17). When the bone-conduction microphone 25 is not in contact with the user, the generating unit 46 designates a signal of an air-conduction sound with a noise being reduced as a sound output for the processing-object frame (No in step S14; step S18).

In the following, the first embodiment will be described with reference to calculation of a correction coefficient, selection of an output sound, and correction of a bone conduction sound. In particular, the following will describe in detail exemplary processes performed by the sound correcting apparatus 10.

[Calculation of Correction Coefficient]

In advance, the sound correcting apparatus 10 in accordance with the first embodiment observes an air conduction sound and a bone conduction sound in an environment in which noise is ignorable, and determines correction coefficient data 31 to make the frequency spectrum of a bone conduction sound identical with the frequency spectrum of an air conduction sound under a noise-ignorable environment. The expression “noise is ignorable” refers to a situation in which a value of SNR for an air conduction sound exceeds a predetermined threshold. In response to, for example, initialization or a user's request to calculate correction coefficient data 31, the sound correcting apparatus 10 calculates a correction coefficient. Using, for example, an input device (not illustrated) mounted on the sound correcting apparatus 10, the user may make a request for the sound correcting apparatus 10 to calculate correction coefficient data 31.

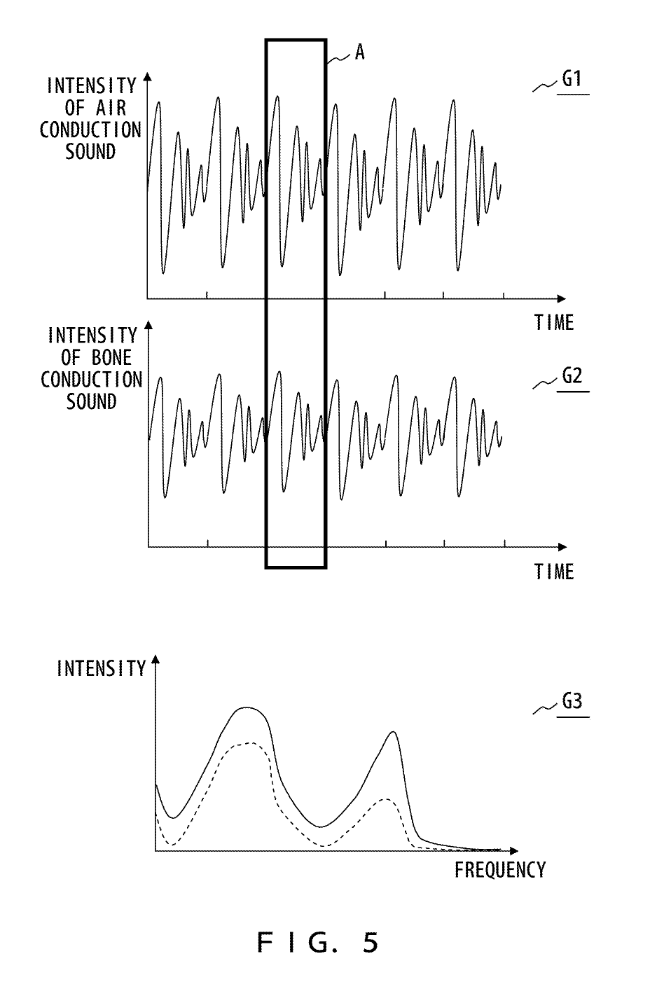

FIG. 5 illustrates an exemplary method for generating a frame and an example of generation of a frequency spectrum. Assume, for example, that a temporal change indicated by a graph G1 in FIG. 5, i.e., an output signal from the air-conduction microphone 20, and a temporal change indicated by a graph G2, i.e., an output signal from the bone-conduction microphone 25, are input to the dividing unit 51. The dividing unit 51 divides the temporal changes in the air conduction sound and the bone conduction sound into frames each having a length determined in advance. The length (period) of one frame is set in accordance with an implementation, and it is, for example, about 20 milliseconds. A rectangle A in FIG. 5 is an example of data included in one frame. For both the air conduction sound and the bone conduction sound, each frame is associated with information corresponding to a period that is identical with the period of the frame. The dividing unit 51 outputs pieces of data (frame data) obtained via the dividing to the transforming unit 52 after associating these pieces of data with a frame number and a data type indicating which of the air conduction sound or the bone conduction sound the pieces of data are. As an example, the data included in the rectangle A in FIG. 5 is output to the transforming unit 52 as the air conduction sound or the bone conduction sound of a t-th frame.

The transforming unit 52 performs Fourier transformation on data on the air conduction sound for each frame, and determines one frequency spectrum from the data on the air conduction sound of one frame. Similarly, for each frame, the transforming unit 52 performs Fourier transformation on data on the bone conduction sound so as to determine a frequency spectrum. During calculation of a correction coefficient by the sound correcting apparatus 10, the transforming unit 52 outputs an obtained frequency spectrum to the bone-conduction-sound correcting unit 43. In this case, for each frequency spectrum, the transforming unit 52 transmits, to the bone-conduction-sound correcting unit 43, the frame number of a frame that includes data used to generate the spectrum, and the type of the data which is associated with the frame number.

The bone-conduction-sound correcting unit 43 calculates the mean amplitude spectrum of the air conduction sound by averaging a preset number of frequency spectrums of the air conduction sound. A graph G3 in FIG. 5 indicates examples of mean amplitude spectrums, and a solid line in the graph G3 is an example of the mean amplitude spectrum of the air conduction sound. Assume, for example, that a frequency band in which the air conduction sound or the bone conduction sound is observed is divided into as many frequency bands as half the number of points of Fourier transformation. In this case, the mean amplitude of the air conduction sound in an i-th frequency band (Fave_a(i)) is determined by the following formula.

$${F}_{ave \_ a} ( i ) = \frac{1}{N} {\sum }_{t = 1}^{N} {f}_{a} ( i , t )$$

The bone-conduction-sound correcting unit 43 also performs a similar process for the bone conduction sound so as to calculate a mean amplitude spectrum. An example of the mean amplitude spectrum of the bone conduction sound is indicated by a dashed line in the graph G3. The mean amplitude of the bone conduction sound in the i-th frequency band (Fave_b(i)) is determined by the following formula.

$${F}_{ave \_ b} ( i ) = \frac{1}{N} {\sum }_{t = 1}^{N} {f}_{b} ( i , t )$$

The bone-conduction-sound correcting unit 43 designates the ratio of the mean amplitude of the bone conduction sound to the mean amplitude of the air conduction sound within the same frequency band as a correction coefficient for that frequency band. As an example, the following formula expresses the correction coefficient of the i-th frequency band (coef_f(i)).

$$coef\_f ( i ) = \frac{{F}_{ave \_ b} ( i )}{{F}_{ave \_ a} ( i )}$$

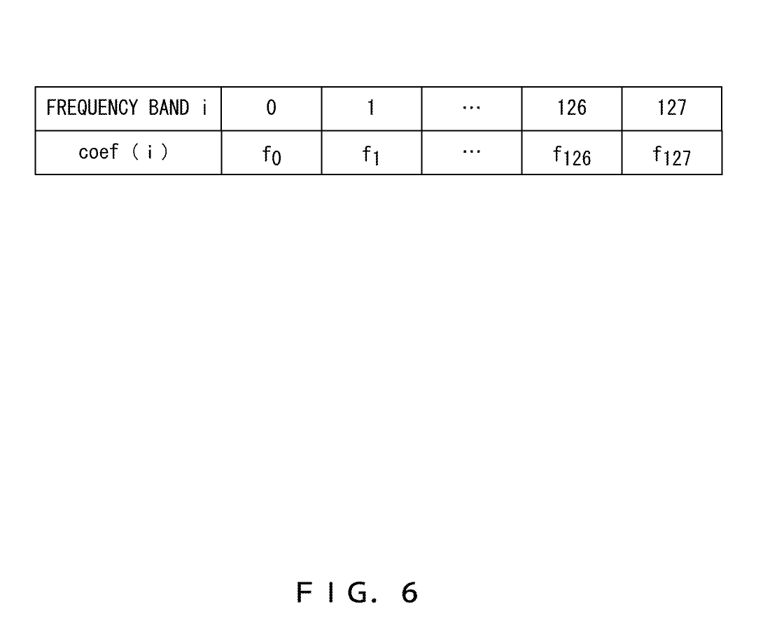

The bone-conduction-sound correcting unit 43 stores obtained correction coefficient data 31 in the storage unit 30. FIG. 6 illustrates a table indicating an example of correction coefficient data 31. The sound correcting apparatus 10 corrects the bone conduction sound using the correction coefficient data 31 stored in the storage unit 30, as long as the correction coefficient is not adjusted.

Descriptions have been given hereinabove of an exemplary case where the sound correcting apparatus 10 calculates and stores a correction coefficient, but a correction coefficient may be calculated using an apparatus that is different from the sound correcting apparatus 10.

When another apparatus calculates a correction coefficient, the sound correcting apparatus 10 obtains the correction coefficient from that another apparatus and stores the obtained coefficient in the storage unit 30. Any methods, including a radio frequency communication, are usable to obtain a correction coefficient.

[Selection of Output Sound]

The following will describe a method for selecting a sound output by the sound correcting apparatus 10.

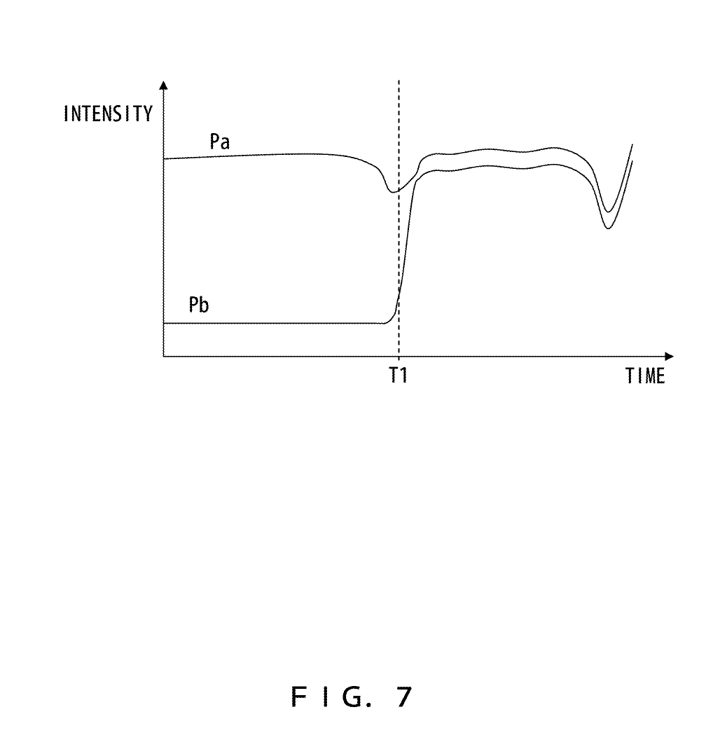

FIG. 7 illustrates examples of temporal changes in the intensities of an air conduction sound and a bone conduction sound. Pa in FIG. 7 indicates an example of a temporal change in the intensity of an air conduction sound obtained via the amplifier 8a and the A/D converter 7a. Meanwhile, Pb indicates an example of a temporal change in the intensity of a bone conduction sound obtained via the amplifier 8b and the A/D converter 7b. When a sound from a user is input to the air-conduction microphone 20 while the bone-conduction microphone 25 is not in contact with a user, the sound is not input to the bone-conduction microphone 25. Hence, when the bone-conduction microphone 25 is not in contact with the user, the intensity of a bone conduction sound becomes very small in comparison with the intensity of an air conduction sound, as seen during the period before time T1 in FIG. 7. Accordingly, for each frame, the contact detecting unit 41 calculates the difference between the intensity of the air conduction sound and the intensity of the bone conduction sound so as to detect that the bone-conduction microphone 25 is in contact with the user.

The following will describe exemplary processes performed for determining for each frame whether the bone-conduction microphone 25 is in contact with the user. In a case that is different from the case of calculating a correction coefficient, the dividing unit 51 also divides sound signals output from the air-conduction microphone 20 and the bone-conduction microphone 25 in accordance with frames, and the transforming unit 52 transforms the divided signals into frequency spectrums each associated with a frame. The transforming unit 52 outputs the obtained frequency spectrums to the contact detecting unit 41 together with information indicating frame numbers and data types.

The contact detecting unit 41 totalizes the powers in frequency bands from the frequency spectrum of the air conduction sound for a processing-object frame so as to calculate the intensity of the air conduction sound for the processing-object frame. The contact detecting unit 41 also calculates a sound intensity for the bone conduction sound in a similar manner. The contact detecting unit 41 determines a ratio of the intensity of the air conduction sound to the intensity of the bone conduction sound. For a frame for which the ratio less than a threshold Tht is obtained, the contact detecting unit 41 judges that the bone-conduction microphone 25 is in contact with the user. When both the intensity of the air conduction sound and the intensity of the bone conduction sound are determined in decibels, the contact detecting unit 41 may compare the difference between the intensities of the air conduction sound and the bone conduction sound with the threshold Tht. Note that the threshold Tht is an arbitrary value wherein the bone conduction sound can be judged to be sufficiently quieter than the air conduction sound. The threshold Tht is set in accordance with the intensities of an air conduction sound and a bone conduction sound input to the dividing unit 51, and hence the gain of the amplifier 8a connected to the air-conduction microphone 20 and the gain of the amplifier 8b connected to the bone-conduction microphone 25 are also considered. The threshold Tht may be set to, for example, about 30 dB.

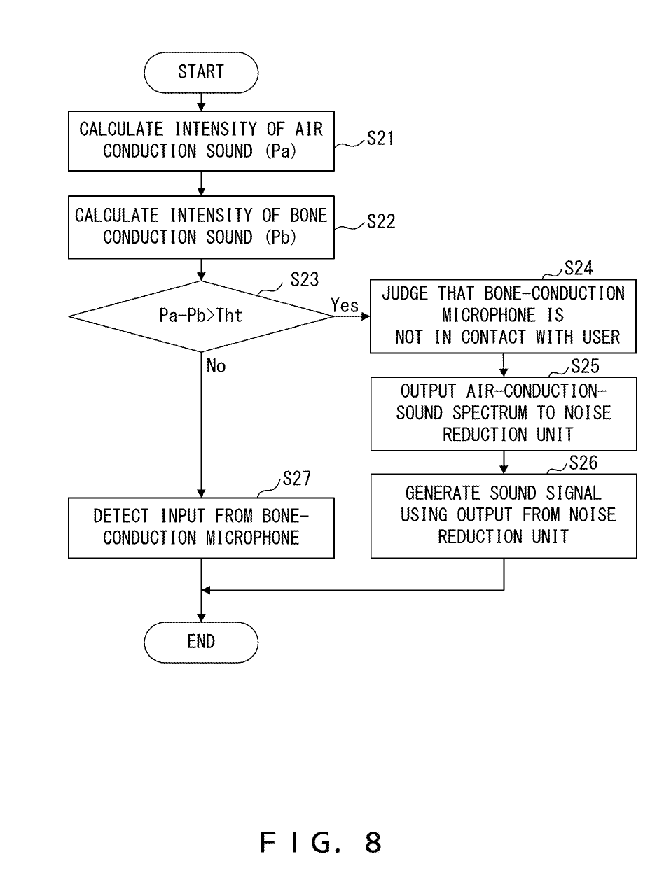

FIG. 8 is a flowchart illustrating exemplary processes performed by the contact detecting unit 41. Note that an order in which steps S21 and S22 are performed may be changed. The contact detecting unit 41 obtains the frequency spectrum of an air conduction sound for a t-th frame from the transforming unit 52 and determines an intensity Pa (dB) of the air conduction sound for the t-th frame (step S21). Then, the contact detecting unit 41 obtains the frequency spectrum of a bone conduction sound for the t-th frame from the transforming unit 52 and determines an intensity Pb (dB) of the bone conduction sound for the t-th frame (step S22). The contact detecting unit 41 determines the difference in intensity between the air conduction sound and the bone conduction sound, both expressed in decibels, and compares the determined value with a threshold Tht (step S23). When the difference in intensity between the air conduction sound and the bone conduction sound expressed in decibels is greater than the threshold Tht, the contact detecting unit 41 judges that the bone-conduction microphone 25 is not in contact with the user (Yes in step S23; step S24). For a frame for which the bone-conduction microphone 25 is judged to be not in contact with the user, the contact detecting unit 41 outputs the frequency spectrum of the air conduction sound to the noise reduction unit 45 (step S25). In addition, the contact detecting unit 41 reports to the generating unit 46 the frame number of the frame for which the bone-conduction microphone 25 is judged to be not in contact with the user, and, for the frame with that number, the contact detecting unit 41 requests that a signal obtained from the noise reduction unit 45 be used to generate a sound signal (step S26).

Meanwhile, when the difference in intensity between the air conduction sound and the bone conduction sound expressed in decibels is equal to or less than the threshold Tht, the contact detecting unit 41 judges that the bone-conduction microphone 25 is in contact with the user and that an input from the bone-conduction microphone 25 is detected (No in step S23; step S27). For a frame for which the bone-conduction microphone 25 is judged to be in contact with the user, the contact detecting unit 41 outputs the frequency spectrums of both the air conduction sound and the bone conduction sound to the class determining unit 42.

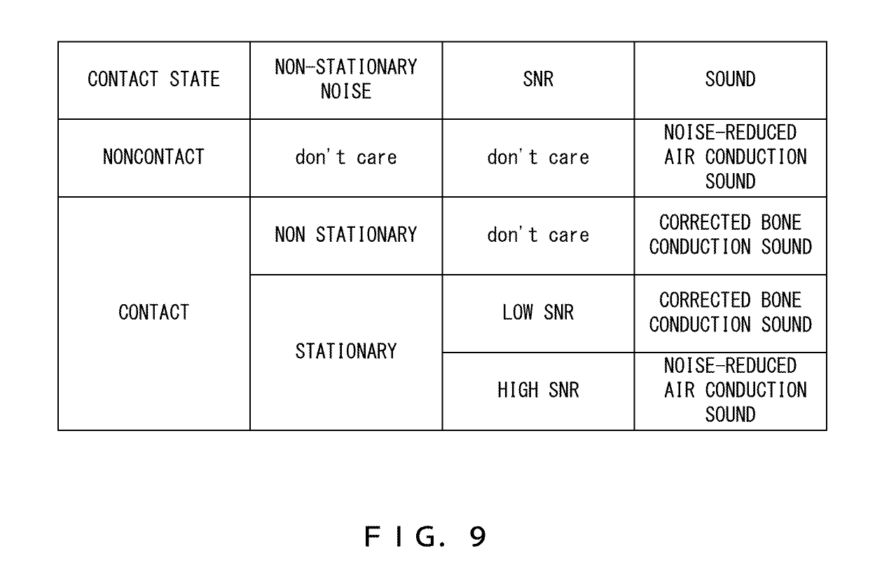

FIG. 9 is a table illustrating an exemplary method for selecting a sound to be output. When the contact detecting unit 41 judges that the bone-conduction microphone 25 is not in contact with the user, regardless of a value of SNR and the presence/absence of a non-stationary noise, the sound correcting apparatus 10 outputs an air conduction sound to which a noise reducing process has been applied. Meanwhile, when the contact detecting unit 41 judges that the bone-conduction microphone 25 is in contact with the user, the class determining unit 42 judges whether a frame includes a non-stationary noise.

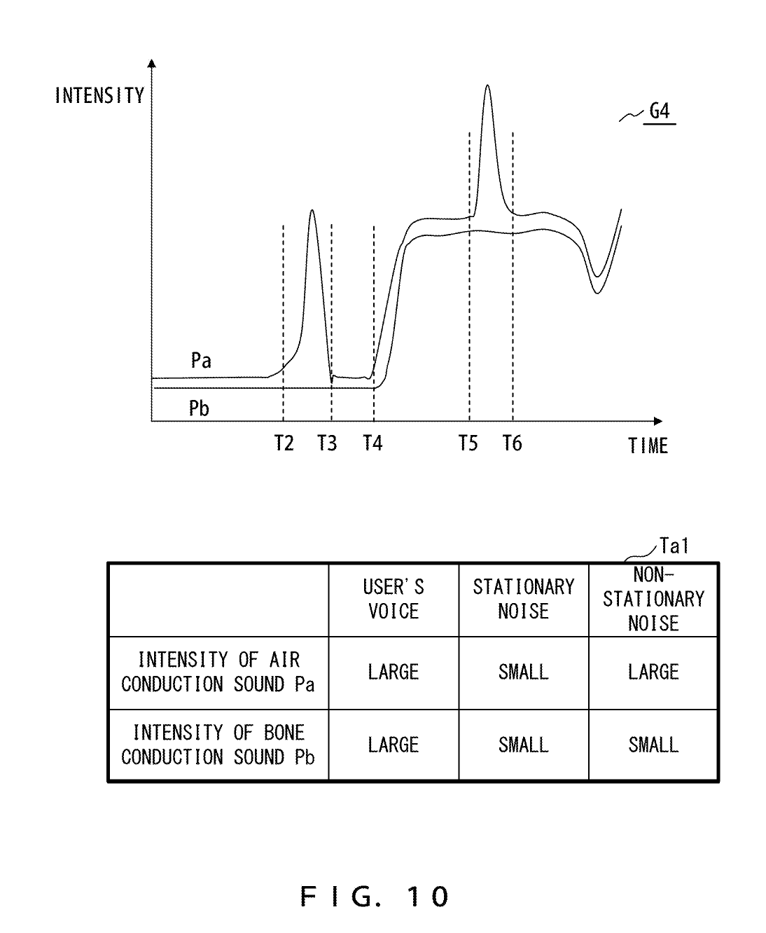

FIG. 10 illustrates an exemplary method for deciding the type of an input sound. A graph G4 in FIG. 10 indicates examples of changes in the intensities of an air conduction sound and a bone conduction sound under a condition in which a non-stationary noise is generated while the bone-conduction microphone 25 is in contact with a user. The graph G4 indicates a situation in which the voice of the user of the sound correcting apparatus 10 is not input to the sound correcting apparatus 10 before time T4 and the voice starts to be input to the sound correcting apparatus 10 at time T4. Non-stationary noises are generated during the period from time T2 to time T3 and the period from time T5 to time T6. When the user's voice is input to the sound correcting apparatus 10 as seen after time T4 in the graph G4, the voice is input to both the air-conduction microphone 20 and the bone-conduction microphone 25, thereby enhancing outputs from both the air-conduction microphone 20 and the bone-conduction microphone 25.

In many cases, non-stationary noise is louder than stationary noise. Hence, when the air-conduction microphone 20 picks up a non-stationary noise, the output from the air-conduction microphone 20 is supposedly large, as indicated by the changes in Pa during the period from time T2 to time T3 and the period from time T5 to time T6. However, the bone-conduction microphone 25 does not pick up a non-stationary noise. Hence, as suggested by the fact that a large change in Pb is not seen during the period from time T2 to time T3 or the period from time T5 to time T6, a non-stationary noise input to the sound correcting apparatus does not affect the output from the bone-conduction microphone 25.

The bone-conduction microphone 25 also does not pick up a stationary noise generated at a place where the user uses the sound correcting apparatus 10. Hence, when a stationary noise is input to the sound correcting apparatus 10 during the period up to time T4, the output from the bone-conduction microphone 25 during the period up to time T4 remains small. Since a stationary noise is quiet in comparison with the user's voice, the output from the air-conduction microphone 20 remains small even when the air-conduction microphone 20 picks up a stationary noise, as indicated by the changes in Pa before time T2 and during the period from time T3 to time T4.

Accordingly, using the criteria indicated in a table Ta1 in FIG. 10, the class determining unit 42 may judge the type of a sound within a frame input from the contact detecting unit 41. When, for example, both intensities of the air conduction sound and the bone conduction sound of an n-th frame are large, the class determining unit 42 judges that the n-th frame includes the user's voice. Meanwhile, when both intensities of the air conduction sound and the bone conduction sound of an m-th frame are small, the class determining unit 42 judges that the m-th frame includes a stationary noise. In addition, when a p-th frame includes a loud air conduction sound (large intensity) and a quiet bone conduction sound (small intensity), the class determining unit 42 judges that the p-th frame includes a non-stationary noise.

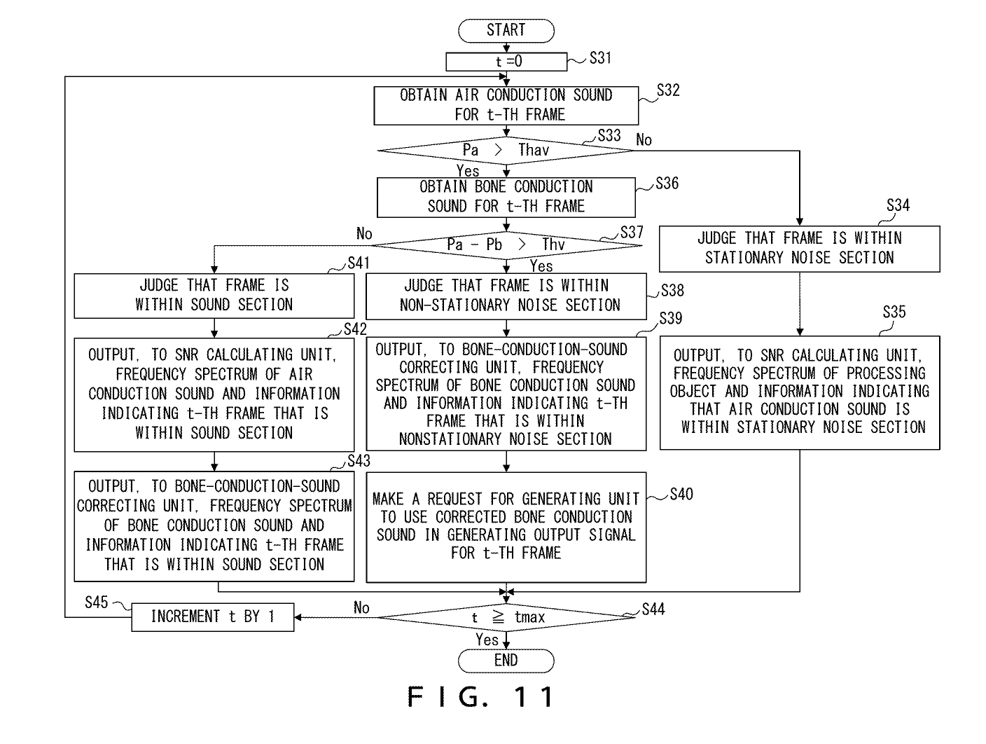

FIG. 11 is a flowchart illustrating exemplary operations performed by the class determining unit 42. In FIG. 11, an order in which steps S39 and S40 are performed may be reversed, and an order in which steps S42 and S43 are performed may be reversed. In addition, in the example depicted in FIG. 11, the class determining unit 42 uses a sound determination threshold (Thav) and a difference threshold (Thv) to judge the type of a sound. The sound determination threshold (Thav) indicates the value of the loudest air conduction sound judged to be a stationary noise. The sound determination threshold Thav may be, for example, −46 dBov. dBov is a unit of measurement that indicates the level of a digital signal, and 0 dBov is the signal level initially obtained when an overload occurs due to the digitalizing of a sound signal. The difference threshold (Thv) is the maximum difference between an air conduction sound and a bone conduction sound within a range where a user's voice is judged to be input to the bone-conduction microphone 25. The difference threshold Thv may be set to, for example, about 30 dB.

When starting processing, the class determining unit 42 sets a variable t to 0 (step S31). The class determining unit 42 obtains the frequency spectrum of an air conduction sound for a t-th frame and compares an air-conduction-sound intensity (Pa) determined from the obtained spectrum with the sound determination threshold (Thav) (steps S32 and S33). When the sound intensity of the air conduction sound of the frame is equal to or lower than the sound determination threshold Thav, the class determining unit 42 judges that the processing-object frame includes a stationary noise (No in step S33; step S34). The class determining unit 42 associates the frequency spectrum of the frame judged to have a stationary noise recorded therein with information indicating that the frame is within a stationary noise section, and outputs the resultant data to the SNR calculating unit 44 (step S35).

Meanwhile, when the air-conduction-sound intensity of the processing-object frame exceeds the threshold Thav, the class determining unit 42 obtains the frequency spectrum of the bone conduction sound for the processing-object frame and determines the sound intensity of the bone conduction sound (Pb) (Yes in step S33; step S36). In addition, the class determining unit 42 compares the difference in intensity between the air conduction sound and the bone conduction sound (Pa−Pb) for the processing-object frame with the threshold Thv (step S37). Note that both of the intensities of the air conduction sound and the bone conduction sound are determined in decibels. When the difference in sound intensity is higher than the threshold Thv, the class determining unit 42 judges that the air conduction sound includes a non-stationary noise (Yes in step S37; step S38). Next, the class determining unit 42 outputs the frequency spectrum of the bone conduction sound for the processing-object frame to the bone-conduction-sound correcting unit 43 in association with a frame number and information indicating that the frequency spectrum is a spectrum obtained from data included in a frame within a non-stationary noise section (step S39). In addition, the class determining unit 42 makes a request for the generating unit 46 to use a sound obtained by correcting the bone conduction sound in the generating of an output signal for the period directed to the t-th frame (step S40).

When it is judged in step S37 that the difference in sound intensity is equal to or lower than the difference threshold Thv, the class determining unit 42 judges that the processing-object frame includes the user's voice (No in step S37; step S41). The class determining unit 42 outputs an air-conduction-sound spectrum for the processing-object frame to the SNR calculating unit 44 in association with a frame number and information indicating that the frame is within a sound section (step S42). The class determining unit 42 outputs the frequency spectrum of the bone conduction sound for the processing-object frame to the bone-conduction-sound correcting unit 43 in association with a frame number and information indicating that the frame is within a sound section (step S43).

When any of the processes of steps S35, S40, and S43 ends, the class determining unit 42 compares the variable t with tmax, i.e., the total number of frames generated by the dividing unit 51 (step S44). When the variable t is lower than tmax, the class determining unit 42 increments the variable t by 1 and repeats the processes of step 32 and the following steps (No in step S44; step S45). Meanwhile, when the variable t is equal to or higher than tmax, the class determining unit 42 judges that all of the frames have been processed, and finishes the flow (Yes in step S44).

As indicated by step S40 in FIG. 11, for a frame judged to be within a non-stationary noise section, the class determining unit 42 makes a request for the generating unit 46 to set a sound obtained by the bone-conduction-sound correcting unit 43 as an output from the sound correcting apparatus 10. For a frame that includes a non-stationary noise, regardless of the value of SNR, the class determining unit 42 makes a request for the generating unit 46 to set a corrected bone conduction sound as a sound output from the sound correcting apparatus 10. Hence, for a frame judged by the class determining unit 42 to include a non-stationary noise, the sound correcting apparatus 10 outputs a corrected bone conduction sound, as depicted in FIG. 9.

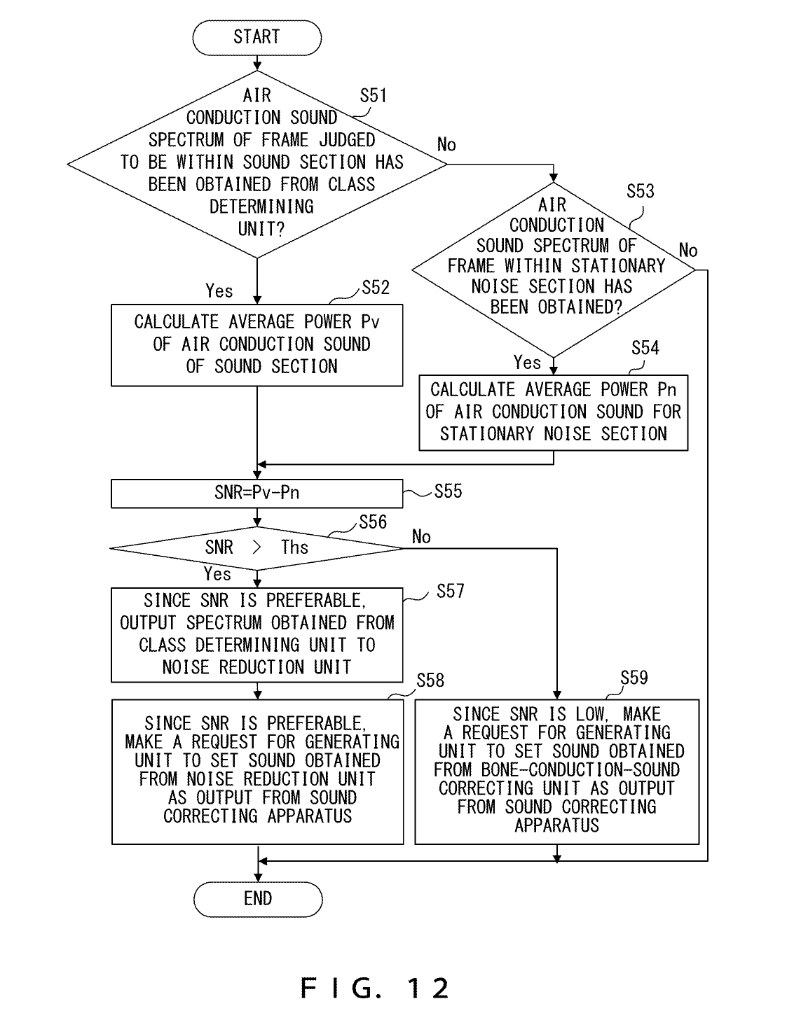

FIG. 12 is a flowchart illustrating exemplary operations performed by the SNR calculating unit 44. The following descriptions are based on the assumption that a threshold Ths is stored in the SNR calculating unit 44 in advance. The threshold Ths, a critical value to judge whether an SNR is preferable, is determined in accordance with an implementation.

The SNR calculating unit 44 judges whether the air-conduction-sound spectrum of a frame judged to be within a sound section has been obtained from the class determining unit 42 (step S51). When obtaining the air-conduction-sound spectrum of the sound section, the SNR calculating unit 44 determines the average power Pv(dBov) of the air conduction sound of the sound section by using the spectrum input from the class determining unit 42 as the frame within the sound section (Yes in step S51; step S52). For example, the average power Pv(t) of the air conduction sound of the sound section for a t-th frame is calculable from the following formula.

Pv(t)=α×P(t)+(1−α)×Pv(t−1)

In the formula, P(t) indicates the power of the air conduction sound for a t-th frame. Pv(t−1) indicates the average power of the air conduction sound of the sound section for a (t−1)-th frame, and α indicates a contribution coefficient representing how much the t-th frame contributes to the average power of the air conduction sound of the sound section. In accordance with an implementation, the contribution coefficient is set to satisfy 0≦α≦1. The contribution coefficient α is stored in the SNR calculating unit 44 in advance.

Meanwhile, when an air-conduction-sound spectrum of a sound section is not obtained, the SNR calculating unit 44 judges whether the obtained air-conduction-sound spectrum is included in a frame within a stationary noise section (No in step S51; step S53). When the input spectrum is not a spectrum obtained from data included in a frame within a stationary noise section, the SNR calculating unit 44 ends the flow (No in step S53). Judging that a spectrum for a stationary noise section has been input, the SNR calculating unit 44 calculates an average power Pn (dBov) for the stationary noise section (Yes in step S53; step S54). The average power Pn for the stationary noise section is calculated using, for example, the following formula.

Pn(t)=β×P(t)+(1−β)×Pn(t−1)

In the formula, β indicates a contribution coefficient representing how much the t-th frame contributes to the average power of the air conduction sound of the stationary noise section. P(t) indicates the power of the air conduction sound for the t-th frame. In accordance with an implementation, the contribution coefficient is set to satisfy 0≦β≦1. The contribution coefficient β is also stored in the SNR calculating unit 44 in advance.

The SNR calculating unit 44 calculates a value of SNR using the average power Pv of the air conduction sound of a sound section and the average power Pn for a stationary noise section (step S55). In this case, SNR=Pv−Pn, because the average power Pv of the air conduction sound of the sound section and the average power Pn for the stationary noise section are both calculated in dBov.

The SNR calculating unit 44 compares the obtained value of SNR with the threshold Ths stored in advance (step S56). When the value of SNR is higher than the threshold Ths, the SNR calculating unit 44 judges that the SNR is preferable and outputs the air-conduction-sound spectrum obtained from the class determining unit 42 to the noise reduction unit 45 (step S57). In addition, the SNR calculating unit 44 reports to the generating unit 46 the frame number of a frame associated with the spectrum output to the noise reduction unit 45, and requests that, for that frame, a sound obtained from the noise reduction unit 45 be set as a sound to be output from the sound correcting apparatus 10 (step S58). Meanwhile, when the value of SNR is equal to or lower than the threshold Ths, the SNR calculating unit 44 makes a request for the generating unit 46 to set a sound obtained from the bone-conduction-sound correcting unit 43 as a sound to be output from the sound correcting apparatus 10 (step S59). In step S59, the SNR calculating unit 44 also reports the frame number obtained from the class determining unit 42 to the generating unit 46 as information for specifying a frame that uses a value obtained from the bone-conduction-sound correcting unit 43.

As indicated by steps S57-S58 in FIG. 12, for a frame with a preferable value of SNR, the SNR calculating unit 44 makes a request for the generating unit 46 to set a sound obtained at the noise reduction unit 45 as an output from the sound correcting apparatus 10. Hence, as depicted in FIG. 9, for a frame with a high value of SNR from among the frames within a sound section, the sound correcting apparatus 10 outputs an air conduction sound with noise reduced. As indicated by step S59 in FIG. 12, for a frame with a low value of SNR, the SNR calculating unit 44 makes a request for the generating unit 46 to set a sound obtained at the bone-conduction-sound correcting unit 43 as an output from the sound correcting apparatus 10. Although a frame obtained from a bone conduction sound is not input to the SNR calculating unit 44, a frame obtained from the bone conduction sound and judged to be within a sound section is output to the bone-conduction-sound correcting unit 43 in step S43, a step described above with reference to FIG. 11. The bone-conduction-sound correcting unit 43 makes a correction to make a bone-conduction-sound spectrum approach the air-conduction-sound spectrum specific to the case of ignorable noise and then outputs obtained data to the generating unit 46. Accordingly, as illustrated in FIG. 9, for a frame with a low value of SNR from among the frames within the sound section, the sound correcting apparatus 10 outputs a corrected bone conduction sound.

[Correction of Bone Conduction Sound]

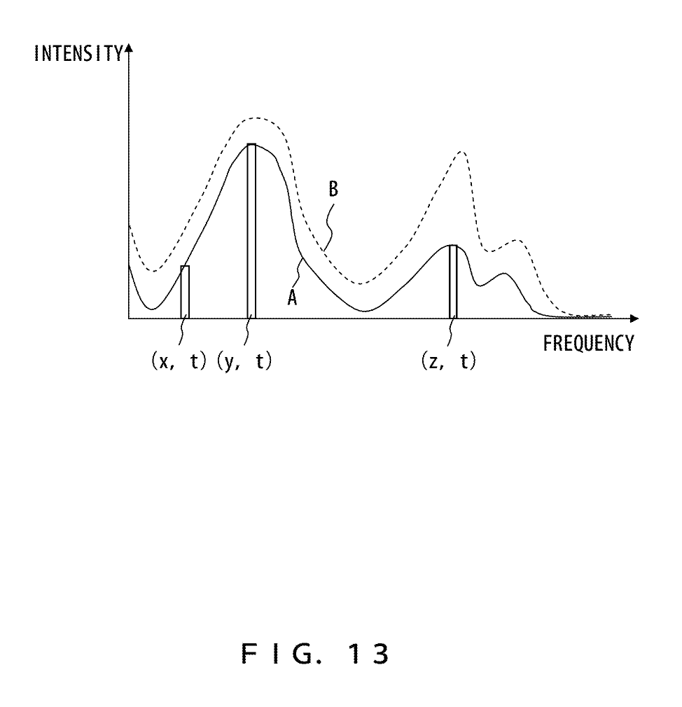

FIG. 13 illustrates an exemplary correcting method used by the bone-conduction-sound correcting unit 43. “A” in FIG. 13 indicates the frequency spectrum of a bone conduction sound of a t-th frame. The bone-conduction-sound correcting unit 43 divides an input frequency spectrum in accordance with frequency bands used to determine a correction coefficient held in advance and obtains an amplitude value for each frequency band. FIG. 13 depicts, as examples, x-th, y-th, and z-th frequency bands and amplitude values thereof. In the following descriptions, a pair of a frequency band number and a frame number will be indicated in parenthesis. As an example, since the frequency spectrum of the bone conduction sound depicted in FIG. 13 is obtained from the t-th frame, the x-th frequency band is indicated as (x, t). Similarly, the y-th frequency band of the frequency spectrum obtained from the t-th frame is indicated as (y, t), and the z-th frequency band of the frequency spectrum obtained from the t-th frame is indicated as (z, t).

For each frequency band, the bone-conduction-sound correcting unit 43 determines the amplitude of a corrected bone conduction sound using the following formula.

Fb_{mod(i,t)}=Fb(i,t)*coef_{—}f(i)

Fb_{mod(i, t)} indicates a corrected amplitude value obtained for the i-th frequency band of the frequency spectrum obtained from the t-th frame. Fb(i, t) indicates a pre-correction amplitude value for the i-th frequency band of the frequency spectrum obtained from the t-th frame. coef_f(i) indicates a correction coefficient for the i-th frequency band. A graph indicated as B in FIG. 13 is obtained by plotting values that the bone-conduction-sound correcting unit 43 obtains in making corrections.

In comparison with the air-conduction microphone 20, the bone-conduction microphone 25 provides small amplitudes within a high frequency domain, thereby muffling a bone conduction sound before correction. However, a correction coefficient may be determined for each frequency band so that high correction coefficients can be used for a high frequency domain in comparison with those used for a low frequency domain. In the example of FIG. 13, the correction coefficients for the x-th, y-th, and z-th frequency bands satisfy:

coef_{—}f(x)≈coef_{—}f(y)<coef_{—}f(z)

Thus, when a correction is made, the percentage of an increase in amplitude is high in the z-th frequency band in comparison with those in the x-th and y-th frequency bands.

When the correcting of a bone conduction sound is finished, the bone-conduction-sound correcting unit 43 outputs an obtained frame to the generating unit 46. When the class determining unit 42 or the SNR calculating unit 44 makes a request to use a corrected bone conduction sound as an output from the sound correcting apparatus 10, the generating unit 46 uses the frame obtained from the bone-conduction-sound correcting unit 43 as an output from the sound correcting apparatus 10. When it is determined for each frame which sound signal is to be used, the generating unit 46 performs inverse Fourier transformation on a frequency spectrum obtained for each frame so as to transform the spectrum into a function of time. The generating unit 46 addresses a signal obtained via inverse Fourier transformation as a signal of a sound input from the user to the sound correcting apparatus 10.

As described above, when a noise largely affects a sound input through an air-conduction microphone, e.g., when a non-stationary noise occurs or when a value of SNR is lower than a threshold, the sound correcting apparatus in accordance with the embodiment outputs a sound obtained by correcting a bone conduction sound to approach an air conduction sound specific to a preferable value of SNR. In this case, the bone-conduction-sound correcting unit 43 uses correction coefficient data 31, i.e., data determined by dividing a frequency spectrum into a plurality of frequency bands, thereby preventing sounds in a high frequency band from being weakened due to the characteristic of the bone-conduction microphone 25. Hence, the user of the sound correcting apparatus 10 or an apparatus communicating with the sound correcting apparatus 10 can easily hear the sound obtained by correcting the bone conduction sound.

The sound correcting apparatus 10 may vary the type of an output sound for each frame in accordance with a value of SNR, the presence/absence of an input to the bone-conduction microphone 25, and the presence/absence of a non-stationary noise, thereby precisely removing noises.

### Second Embodiment

With reference to a second embodiment, descriptions will be given of operations performed by the sound correcting apparatus 10 when a correction coefficient is adjusted in real time.

In the second embodiment, when the air-conduction-sound spectrums for frames within a sound section are input, the SNR calculating unit 44 determines a value of SNR for each frame, as in the first embodiment. In addition, when a value of SNR is equal to or lower than a threshold Ths, the SNR calculating unit 44 divides the frequency spectrum into a plurality of frequency bands and determines a value of SNR for each frequency band. The following will describe how to determine a value of SNR for each frequency band.

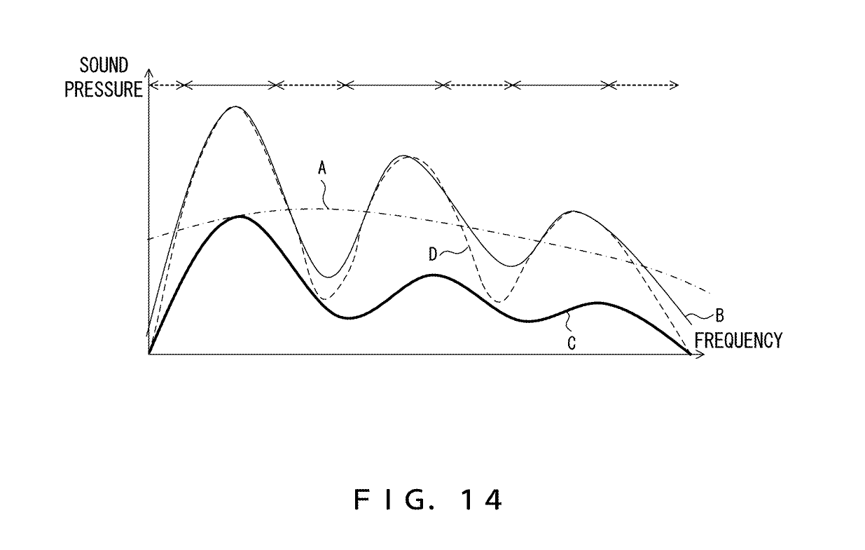

In the second embodiment, obtaining frequency spectrums of a stationary noise from the class determining unit 42, the SNR calculating unit 44 calculates the average spectrum of the stationary noise. “A” in FIG. 14 indicates an exemplary average spectrum of a stationary noise. The SNR calculating unit 44 divides the average spectrum of the stationary noise into a plurality of frequency bands and determines the average value of the intensity of the stationary noise for each frequency band.

For the frequency spectrums of an air conduction sound for frames that have a value of SNR equal to or lower than the threshold Ths, as a whole, the SNR calculating unit 44 specifies an intensity for each frequency band, as in the case of the spectrums of the stationary noise, and divides the specified intensity by the average value of the intensity of the stationary noise in that band. As an example, when the SNR calculating unit 44 obtains, as an air-conduction-sound spectrum for a frame within a sound section, a frequency spectrum such as that depicted by B in FIG. 14, the SNR calculating unit 44 calculates a value of SNR for each frequency band. The SNR calculating unit 44 reports, to the bone-conduction-sound correcting unit 43, the calculated values of SNR in association with corresponding frequency bands. A value of SNR obtained for the i-th frequency band within the t-th frame will hereinafter be indicated as SNR(i, t). Using the obtained values of SNR, the bone-conduction-sound correcting unit 43 adjusts a correction coefficient for each frequency band.

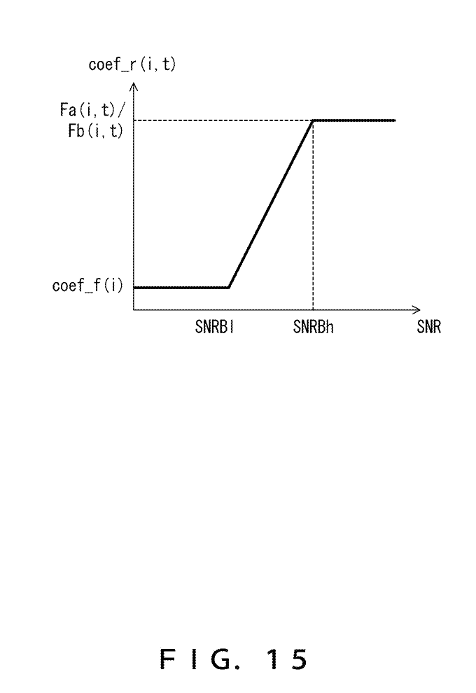

FIG. 15 is a graph illustrating an exemplary method for adjusting a correction coefficient, wherein the method is used by the bone-conduction-sound correcting unit 43. Note that the sound correcting apparatus 10 in accordance with the second embodiment stores a threshold SNRBl and a threshold SNRBh. The threshold SNRBl is the minimum value of SNR of an air conduction sound at which a correction coefficient can be adjusted in real time using the frequency spectrum of the air conduction sound. Meanwhile, the threshold SNRBh is the minimum value of SNR at which it is determined that correction coefficient data 31 does not need to be used in the adjusting of a correction coefficient in real time. For each frequency band, the bone-conduction-sound correcting unit 43 compares a value of SNR with the threshold SNRBl and the threshold SNRBh.

When a value of SNR for a processing-object frequency band is equal to or lower than the threshold SNRBl, the bone-conduction-sound correcting unit 43 uses a value included in correction coefficient data 31 as a correction coefficient without adjusting this value. When a value of SNR for a processing-object frequency band is between the threshold SNRBl and the threshold SNRBh, the bone-conduction-sound correcting unit 43 adjusts a correction coefficient using the following formula.

$$coef\_r ( i , t ) = coef\_f ( i ) + \frac{SNR ( i , t ) - SNRBl}{SNRBh - SNRBl} ( \frac{Fa ( i , t )}{Fb ( i , t )} - coef\_f ( i ) )$$

In this formula, coef_r(i, t) is a correction coefficient obtained as a result of an adjustment for the i-th frequency band of the t-th frame. Meanwhile, coef_f(i) is a correction coefficient included in correction coefficient data 31 for the i-th frequency band.

When a value of SNR for a processing-object frequency band is equal to or higher than the threshold SNRBh, without using correction coefficient data 31, the bone-conduction-sound correcting unit 43 uses, as a correction coefficient, the ratio of the intensity of the air conduction sound for the processing-object frequency band to the intensity of a bone conduction sound for the processing-object frequency band.

“C” in FIG. 14 indicates an example of the frequency spectrum of the bone conduction sound of a frame judged to be within a sound section. “D” in FIG. 14 indicates a bone-conduction-sound spectrum corrected using an adjusted correction coefficient obtained using the method indicated in FIG. 15. The sections indicated using solid-line arrows in FIG. 14 have a relatively good value of SNR for each frequency band. Accordingly, for the sections indicated using solid-line arrows in FIG. 14, an adjustment is made such that the intensity of the bone conduction sound approaches the intensity of the air conduction sound. Meanwhile, the sections indicated using dashed-line arrows in FIG. 14 have a relatively bad value of SNR for each frequency band. Accordingly, for the sections indicated using dashed-line arrows in FIG. 14, without making an adjustment such that the intensity of the bone conduction sound becomes identical with the intensity of the air conduction sound, an adjustment is made according to correction coefficient data 31 determined in advance. Thus, for the sections with a bad value of SNR, the influence of noise within the air conduction sound is suppressed; for the sections with a good value of SNR, an adjustment is made such that the bone conduction sound approaches the air conduction sound. In this way, the bone conduction sound is corrected in a manner such that the user can easily hear it.

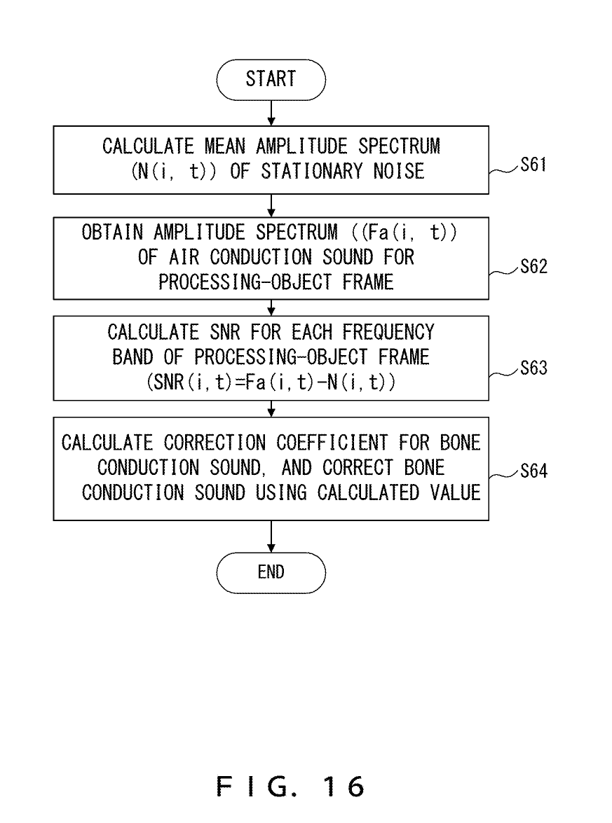

FIG. 16 is a flowchart illustrating exemplary processes performed by the bone-conduction-sound correcting unit to adjust a correction coefficient. Using the frequency spectrum of an air conduction sound for a frame judged to include a stationary noise, the SNR calculating unit 44 calculates the mean amplitude spectrum of the stationary noise (step S61). The SNR calculating unit 44 obtains from the class determining unit 42 an air-conduction-sound spectrum for a frame judged to be within a sound section (step S62). Using an air-conduction-sound spectrum input from the class determining unit 42 and the mean frequency spectrum of the stationary noise, the SNR calculating unit 44 calculates a value of SNR for each frequency band of the air conduction sound for a processing-object frame (step S63). The bone-conduction-sound correcting unit 43 determines a correction coefficient for each frequency band using the values of SNR reported from the SNR calculating unit 44 and corrects the bone conduction sound using the determined correction coefficients (step S64).

The sound correcting apparatus 10 in accordance with the second embodiment is capable of adjusting a correction coefficient for each frequency band within a frame, and thus, for a frequency band with a better value of SNR, is capable of making the intensity of a bone conduction sound closer to the intensity of an air conduction sound. In addition, for a frequency band with a value of SNR that is worse than a predetermined value, processing is performed using correction coefficient data 31 determined in advance. Hence, a decrease in a value of SNR does not affect the correcting of a bone conduction sound. Accordingly, in the second embodiment, bone conduction sounds may be precisely corrected in real time. Consequently, the sound correcting apparatus 10 may output noise-suppressed sounds that are clear and easily heard by a user or a person communicating with the user.

### Third Embodiment

With reference to the third embodiment, descriptions will be given of operations performed by the sound correcting apparatus 10 that is capable of dividing the frequency band of a sound signal into a low frequency band and a high frequency band.

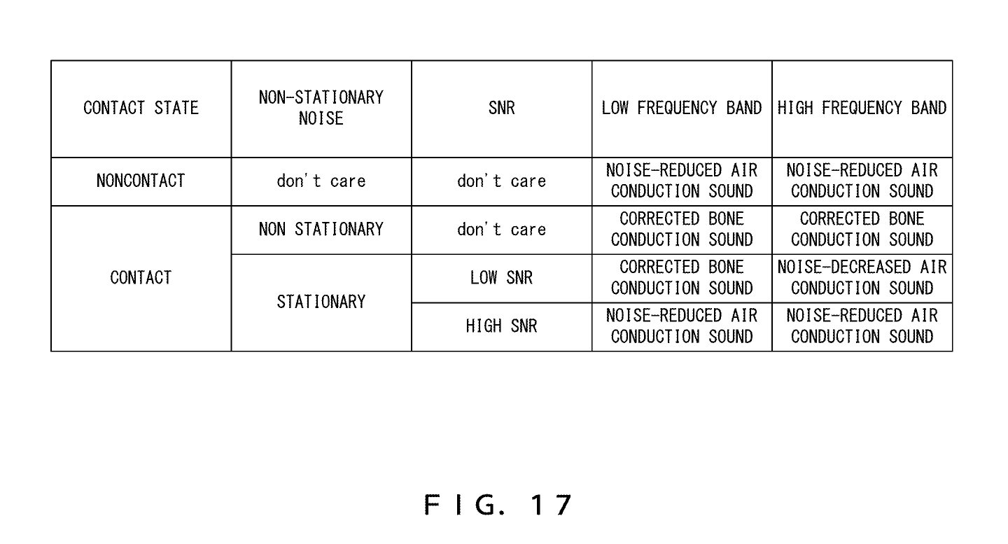

FIG. 17 is a table illustrating an exemplary method for selecting a sound to be output. In the third embodiment, when a sound is picked up in the presence of a stationary noise and the value of SNR of a frame is low, a corrected bone conduction sound is used for a low frequency band, and a noise-reduced air conduction sound is used for a high frequency band. A frequency threshold Thfr is stored in the sound correcting apparatus 10 in advance, and the sound correcting apparatus 10 defines a frequency that is less than the threshold Thfr as a low frequency band and defines a frequency that is equal to or greater than the threshold Thfr as a high frequency band. That is, the generating unit 46 picks up a sound in the presence of a stationary noise and, for a frame with a low value of SNR, generates a composite signal that includes a low frequency component whose intensity is equal to the intensity of a corrected bone conduction sound and a high frequency component whose intensity is equal to the intensity of an air conduction sound. The generating unit 46 performs Fourier transformation on the generated composite signal so as to generate a time-domain sound signal as an output from the sound correcting apparatus 10.

For frames for which the bone-conduction microphone 25 is not in contact with the user, for frames that include a non-stationary noise, and for a frame with high values of SNR as a whole, the generating unit 46 generates output signals using objects similar to those used in the first and second embodiments.

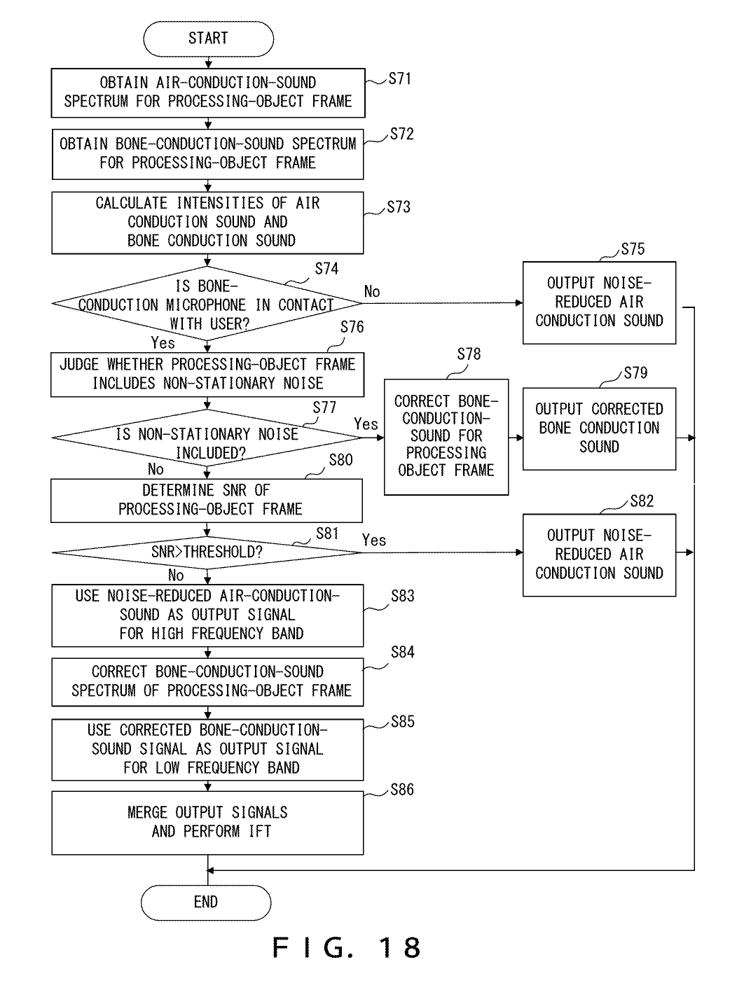

FIG. 18 is a flowchart illustrating exemplary processes performed in the third embodiment. Note that the order in which steps S71 and S72 are performed is reversible.

The contact detecting unit 41 obtains, from the transforming unit 52, the frequency spectrum of an air conduction sound and the frequency spectrum of a bone conduction sound for a processing-object frame (steps S71 and S72). The contact detecting unit 41 performs a totalization process for the frequency spectrum of the air conduction sound and the frequency spectrum of the bone conduction sound so as to calculate the intensities of the air conduction sound and the bone conduction sound (step S73). When judging that the bone-conduction microphone 25 is not in contact with the user, the contact detecting unit 41 makes a request for the generating unit 46 to generate an output signal from the air conduction sound to which a noise reduction process has been applied (No in step S74; step S75).

Meanwhile, when the bone-conduction microphone 25 is in contact with the user, the class determining unit 42 judges whether the processing-object frame includes a non-stationary noise (Yes in step S74; step S76). When a non-stationary noise is included, the bone-conduction-sound correcting unit 43 corrects the bone conduction sound for the processing-object frame (Yes in step S77; step S78). Judging that a non-stationary noise is included, the class determining unit 42 makes a request for the generating unit 46 to set the corrected bone conduction sound as an output signal, and the generating unit 46 sets the corrected bone conduction sound as an object to be output (step S79).

When a non-stationary noise is not included, the SNR calculating unit 44 determines the value of SNR for the processing-object frame and judges whether the value of SNR is higher than a threshold Ths (steps S80 and S81). When the SNR is higher than the threshold Ths, the SNR calculating unit 44 makes a request for the generating unit 46 to generate an output signal from the air conduction sound to which a noise reduction process has been applied (Yes in step S81; step S82).

Meanwhile, when the value of SNR is equal to or lower than the threshold Ths, the generating unit 46 divides the air conduction sound from the noise reduction unit 45 to which the noise reduction process has been applied into a low-frequency band and a high-frequency band and uses a high-frequency band component as an output signal (No in step S81; step S83). The bone-conduction-sound correcting unit 43 corrects the bone conduction sound for the objective frame and outputs the corrected sound to the generating unit 46 (step S84). The generating unit 46 divides the corrected bone conduction sound from the bone-conduction-sound correcting unit 43 into a low-frequency band and a high-frequency band and uses a low frequency band component as an output signal (step S85). The generating unit 46 merges the signals obtained through steps S83-S85, and performs inverse Fourier transformation (IFT) on the resultant signal so as to generate a time-domain sound signal (step S86).

The bone-conduction-sound correcting unit 43 included in the sound correcting apparatus 10 in accordance with the third embodiment may correct a bone conduction sound using either of the methods in accordance with the first and second embodiments.

In the third embodiment, for high frequency components of a bone conduction sound, i.e., for components that tend to produce unclear sounds, a noise-reduced air conduction sound may be used to generate a natural sound that can be easily heard.

As described above, the sound correcting apparatus and the sound correcting method in accordance with the embodiments may reduce noises and generate sound signals that are easily heard.

<Other Items>

The invention is not limited to the aforementioned embodiments, and various modifications can be made thereto. The following are examples of such modifications.

As an example, the dividing unit 51 may associate information indicating the period of obtainment of data included in a frame with each divided data rather than with a frame number.

In addition, the tables and the various types of data used in the descriptions above are examples and thus may be arbitrarily changed in accordance with an implementation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A sound correcting apparatus comprising:
an air-conduction microphone configured to pick up an air conduction sound using aerial vibrations;
a bone-conduction microphone configured to pick up a bone conduction sound using bone vibrations of a user;
a processor configured to process the air conduction sound and the bone conduction sound; and
a memory configured to store data used by the processor, wherein
the processor calculates a ratio of a voice of the user for the air conduction sound to a noise,
the memory stores a correction coefficient for making a frequency spectrum of the bone conduction sound identical with a frequency spectrum of the air conduction sound which corresponds to the ratio that is equal to or greater than a first threshold, and
the processor
corrects the bone conduction sound using the correction coefficient, and
generates an output signal from the corrected bone conduction sound when the ratio is less than a second threshold.

2. The sound correcting apparatus according to claim 1, wherein
the processor
divides a period during which the bone conduction sound and the air conduction sound are picked up into a plurality of frames, and divides the bone conduction sound and the air conduction sound in accordance with the plurality of frames,
determines that an objective frame, which is a processing object, includes a non-stationary noise when a difference between an intensity of the air conduction sound divided in accordance with the objective frame and an intensity of the bone conduction sound divided in accordance with the objective frame is equal to or greater than a third threshold, and
generates a sound signal corresponding to the objective frame from the corrected bone conduction sound when the objective frame includes a non-stationary noise.

3. The sound correcting apparatus according to claim 2, wherein
the processor
determines the ratio for the air conduction sound of the objective frame when the objective frame is judged to not include a non-stationary noise, and
when the ratio for the air conduction sound of the objective frame is equal to or greater than the second threshold, generates a sound signal corresponding to the objective frame using data of the air conduction sound of the objective frame.

4. The sound correcting apparatus according to claim 2, wherein
the processor generates a composite signal from the corrected bone conduction sound and the air conduction sound when the objective frame is judged to not include a non-stationary noise and the ratio for the air conduction sound of the objective frame is less than the second threshold,
the composite signal includes a first frequency component corresponding to a frequency that is lower than a predetermined frequency and having an intensity equal to an intensity of the corrected bone conduction sound, and a second frequency component corresponding to a frequency that is equal to or higher than the predetermined frequency and having an intensity equal to an intensity of the air conduction sound, and
the processor generates a sound signal corresponding to the objective frame from the composite signal.

5. The sound correcting apparatus according to claim 2, wherein
the processor
transforms the air conduction sound for the objective frame into a first frequency spectrum, and transforms the bone conduction sound for the objective frame into a second frequency spectrum,
under a condition in which a frame from among the plurality of frames that includes an air conduction sound having an intensity equal to or less than a fourth threshold is defined as a frame including a stationary noise, determines a noise spectrum, which is a frequency spectrum of the stationary noise,
divides the first frequency spectrum, the second frequency spectrum, and the noise spectrum into a plurality of frequency bands,
for a first frequency band where a value of the first frequency spectrum is higher than a value of the noise spectrum by a fifth threshold or greater, determines an adjusted value obtained by making a correction coefficient for the first frequency band approach a calculated ratio, the calculated ratio being a ratio between a value of the first frequency spectrum within the first frequency band and a value of the second frequency spectrum within the first frequency band,
corrects a value of the first frequency band of the second frequency spectrum using the adjusted value, and
for a second frequency band where the value of the first frequency spectrum is lower than a sum of the fifth threshold and the value of the noise spectrum, corrects a value of the second frequency band of the second frequency spectrum using a correction coefficient for the second frequency band.

6. A computer-readable recording medium having stored therein a program for causing a sound correcting apparatus to execute a process, the sound correcting apparatus including an air-conduction microphone configured to pick up an air conduction sound using aerial vibrations and a bone-conduction microphone configured to pick up a bone conduction sound using bone vibrations of a user, the process comprising:
calculating a ratio of a voice of the user for the air conduction sound to a noise;
obtaining a correction coefficient for making a frequency spectrum of the bone conduction sound identical with a frequency spectrum of the air conduction sound which corresponds to the ratio that is equal to or greater than a first threshold;
correcting the bone conduction sound using the correction coefficient; and
generating an output signal from the corrected bone conduction sound when the ratio is less than a second threshold.

7. The recording medium according to claim 6, wherein
the process further comprises:
dividing a period during which the bone conduction sound and the air conduction sound are picked up into a plurality of frames;
dividing the bone conduction sound and the air conduction sound in accordance with the plurality of frames;
determining that an objective frame, which is a processing object, includes a non-stationary noise when a difference between an intensity of the air conduction sound divided in accordance with the objective frame and an intensity of the bone conduction sound divided in accordance with the objective frame is equal to or greater than a third threshold; and
generating a sound signal corresponding to the objective frame from the corrected bone conduction sound when the objective frame includes a non-stationary noise.

8. The recording medium according to claim 7, wherein
the process further comprises:
determining the ratio for the air conduction sound of the objective frame when the objective frame does not include a non-stationary noise; and
when the ratio for the air conduction sound of the objective frame is equal to or greater than the second threshold, generating a sound signal corresponding to the objective frame using data of the air conduction sound of the objective frame.

9. The recording medium according to claim 7, wherein
the process further comprises:
generating a composite signal from the corrected bone conduction sound and the air conduction sound when the objective frame does not include a non-stationary noise and the ratio for the air conduction sound of the objective frame is less than the second threshold, wherein
the composite signal includes a first frequency component corresponding to a frequency that is lower than a predetermined frequency and having an intensity equal to an intensity of the corrected bone conduction sound, and a second frequency component corresponding to a frequency that is equal to or higher than the predetermined frequency and having an intensity equal to an intensity of the air conduction sound; and
generating a sound signal corresponding to the objective frame from the composite signal.

10. The recording medium according to claim 7, wherein
the process further comprises:
transforming the air conduction sound for the objective frame into a first frequency spectrum;
transforming the bone conduction sound for the objective frame into a second frequency spectrum;
under a condition in which a frame from among the plurality of frames that includes an air conduction sound having an intensity equal to or less than a fourth threshold is defined as a frame including a stationary noise, determining a noise spectrum, which is a frequency spectrum of the stationary noise;
dividing the first frequency spectrum, the second frequency spectrum, and the noise spectrum into a plurality of frequency bands;
for a first frequency band where a value of the first frequency spectrum is higher than a value of the noise spectrum by a fifth threshold or greater, determining an adjusted value obtained by making a correction coefficient for the first frequency band approach a calculated ratio, the calculated ratio being a ratio between a value of the first frequency spectrum within the first frequency band and a value of the second frequency spectrum within the first frequency band;
correcting a value of the first frequency band of the second frequency spectrum using the adjusted value; and
for a second frequency band where the value of the first frequency spectrum is lower than a sum of the values of the noise spectrum and the fifth threshold, correcting a value of the second frequency band of the second frequency spectrum using a correction coefficient for the second frequency band.

11. A sound correcting method executed by a sound correcting apparatus including an air-conduction microphone configured to pick up an air conduction sound using aerial vibrations, and a bone-conduction microphone configured to pick up a bone conduction sound using bone vibrations of a user, the method comprising:
calculating, by the sound correcting apparatus, a ratio of a voice of the user for the air conduction sound to a noise,
obtaining, by the sound correcting apparatus, a correction coefficient for making a frequency spectrum of the bone conduction sound identical with a frequency spectrum of the air conduction sound which corresponds to the ratio that is equal to or greater than a first threshold,
correcting, by the sound correcting apparatus, the bone conduction sound using the correction coefficient, and
generating, by the sound correcting apparatus, an output signal from the corrected bone conduction sound when the ratio is less than a second threshold.
